(19) United States
(12) Patent Application Publication
(10) Pub. No.: US 2026/0032307 A1
(43) Pub. Date: Jan. 29, 2026

(54) DELAY OPTIMIZATION FOR MULTIPLE AUDIO STREAMS

(71) Applicant: QUALCOMM Incorporated, San Diego, CA (US)

(72) Inventors: Nan ZHANG, Beijing (CN); Yongjun XU, Beijing (CN); Wenkai YAO, Beijing (CN)

(21) Appl. No.: 18/993,992

(22) PCT Filed: Aug. 26, 2022
(86) PCT No.: PCT/CN2022/115118

§ 371 Date: Jan. 13, 2025

(51) Int. Cl. H04N 21/439; G10L 19/008; H04N 21/43

(52) U.S. Cl. CPC H04N 21/4392; G10L 19/008; H04N 21/43076

(57) ABSTRACT

Techniques are described herein for audio processing. For instance, a technique can include determining a plurality of coder-decoder (codec) delay values for a plurality of audio devices, wherein each codec delay value is associated with at least one audio device of the plurality of audio devices, selecting a first codec delay value from the plurality of codec delay values, wherein the first codec delay value is associated with a first audio device of the plurality of audio devices, selecting, for a second audio device of the plurality of audio devices, a second codec delay value from a plurality of codec delay values associated with the second audio device, determining a calibration time delay between the first codec delay value and the second codec delay value, and outputting the calibration time delay.

### CROSS-REFERENCE TO RELATED APPLICATIONS

This application for Patent is a 371 of international Patent Application PCT/CN2022/115118, filed Aug. 26, 2022, which is hereby incorporated by referenced in its entirety and for all purposes.

### FIELD

The present disclosure generally relates to audio processing (e.g., playback of a digital audio stream or file to audio data). For example, aspects of the present disclosure are related to systems and techniques for optimizing delays for multiple audio streams.

### BACKGROUND

Network-based interactive systems allow users to interact with one another over a network, in some cases even when those users are geographically remote from one another. Network-based interactive systems can include technologies similar to video conferencing technologies. In a video conference, each user connects through a user device that captures video and/or audio of the user and sends the video and/or audio to the other users in the video conference, so that each of the users in the video conference can see and hear one another. Network-based interactive systems can include network-based multiplayer games, such as massively multiplayer online (MMO) games. Network-based interactive systems can include extended reality (XR) technologies, such as virtual reality (VR) or augmented reality (AR). At least a portion of an XR environment displayed to a user of an XR device can be virtual, in some examples including representations of other users that the user can interact with in the XR environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for audio processing. In one illustrative example, an apparatus for audio processing comprising at least one memory and at least one processor coupled to the at least one memory and a plurality of audio devices. In the apparatus, the at least one processor is configured to determine a plurality of coder-decoder (codec) delay values for the plurality of audio devices, wherein each codec delay value is associated with at least one audio device of the plurality of audio devices, select a first codec delay value from the plurality of codec delay values, wherein the first codec delay value is associated with a first audio device of the plurality of audio devices, select, for a second audio device of the plurality of audio devices, a second codec delay value from a plurality of codec delay values associated with the second audio device, determine a calibration time delay between the first codec delay value and the second codec delay value, and output the calibration time delay.

In another example, a method for audio processing can include determining a plurality of coder-decoder (codec) delay values for a plurality of audio devices, wherein each codec delay value is associated with at least one audio device of the plurality of audio devices, selecting a first codec delay value from the plurality of codec delay values, wherein the first codec delay value is associated with a first audio device of the plurality of audio devices, selecting, for a second audio device of the plurality of audio devices, a second codec delay value from a plurality of codec delay values associated with the second audio device. determining a calibration time delay between the first codec delay value and the second codec delay value, and outputting the calibration time delay.

As another example, a non-transitory computer-readable medium for audio processing having stored thereon instructions that, when executed by at least one processor, cause the at least one processor to: determine a plurality of coder-decoder (codec) delay values for a plurality of audio devices, wherein each codec delay value is associated with at least one audio device of the plurality of audio devices, select a first codec delay value from the plurality of codec delay values, wherein the first codec delay value is associated with a first audio device of the plurality of audio devices, select, for a second audio device of the plurality of audio devices, a second codec delay value from a plurality of codec delay values associated with the second audio device, determine a calibration time delay between the first codec delay value and the second codec delay value, and output the calibration time delay.

In another example, an apparatus for audio processing, the apparatus including: means for determining a plurality of coder-decoder (codec) delay values for a plurality of audio devices, wherein each codec delay value is associated with at least one audio device of the plurality of audio devices, means for selecting a first codec delay value from the plurality of codec delay values, wherein the first codec delay value is associated with a first audio device of the plurality of audio devices, means for selecting, for a second audio device of the plurality of audio devices, a second codec delay value from a plurality of codec delay values associated with the second audio device, means for determining a calibration time delay between the first codec delay value and the second codec delay value, and means for outputting the calibration time delay.

In some aspects, the apparatus comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2 is a block diagram illustrating reception of an audio signal using separate microphones, in accordance with aspects of the present disclosure;

FIG. 3 is a block diagram of an example audio device for generating audio with embedded timing information, in accordance with aspects of the present disclosure;

FIG. 4A is a perspective diagram illustrating a head-mounted display (HMD) that performs feature tracking and/or visual simultaneous localization and mapping (VSLAM), in accordance with some examples;

FIG. 4B is a perspective diagram illustrating the head-mounted display (HMD) of FIG. 4A being worn by a user, in accordance with some examples;

FIG. 5 is a logical view of a multi-user environment 500 with a shared host device, in accordance with aspects of the present disclosure;

FIG. 6 is a flow diagram 600 illustrating processes of a host device, in accordance with aspects of the present disclosure

FIG. 7 is a flow diagram illustrating a process for audio processing, in accordance with aspects of the present disclosure;

FIG. 8 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Extended reality (XR) systems or devices can provide virtual content to a user and/or can combine real-world views of physical environments (scenes) and virtual environments (including virtual content). XR systems facilitate user interactions with such combined XR environments. The real-world view can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

Video conferencing is a network-based technology that allows multiple users, who may each be in different locations, to connect in a video conference over a network using respective user devices that generally each include displays and cameras. In video conferencing, each camera of each user device captures image data representing the user who is using that user device, and sends that image data to the other user devices connected to the video conference, to be displayed on the display of the other users who use those other user devices. Meanwhile, the user device displays image data representing the other users in the video conference, captured by the respective cameras of the other user devices that those other users use to connect to the video conference. Video conferencing can be used by a group of users to virtually speak face-to-face while users are in different locations. Video conferencing can be a valuable way to users to virtually meet with each other despite travel restrictions, such as those related to a pandemic. Video conferencing can be performed using user devices that connect to each other, in some cases through one or more servers. In some examples, the user devices can include laptops, phones, tablet computers, mobile handsets, video game consoles, vehicle computers, desktop computers, wearable devices, televisions, media centers, XR systems, or other computing devices discussed herein.

Network-based interactive systems allow users to interact with one another over a network, in some cases even when those users are geographically remote from one another. Network-based interactive systems can include video conferencing technologies such as those described above. Network-based interactive systems can include extended reality (XR) technologies, such as those described above. At least a portion of an XR environment displayed to a user of an XR device can be virtual, in some examples including representations of other users that the user can interact with in the XR environment. Network-based interactive systems can include network-based multiplayer games, such as massively multiplayer online (MMO) games. Network-based interactive systems can include network-based interactive environment, such as “metaverse” environments.

In some examples, network-based interactive systems may use sensors to capture sensor data and obtain, in the sensor data, representation(s) of user and/or portions of the real-world environment that the user is in. For instance, the network-based interactive systems may use cameras (e.g., image sensors of cameras) and microphones (e.g., audio sensors, microphones, microphone arrays, etc.) to capture image data and sound to obtain image and audio data pertaining to a user and/or portions of the real-world environment that the user is in. In some examples, network-based interactive systems send this sensor data (e.g., image data and audio data) to other users.

In some cases, a well-timed and synchronized presentation of image data and audio data as between users of network-based interactive systems or video conferencing systems can enhance shared experiences and deepen immersion of users within the interactive environment. For example, audio that is synchronized with the displayed video (e.g., lips synchronized with uttered sounds) can enhance user experiences. Similarly, a low latency for audio (e.g., a lower delay between when a user makes a sound and when other users hear the sound) can enhance user experiences. In some cases, multiple users participating in network-based interactive systems or video conferencing systems via a host device may use a variety of audio output devices attached (e.g., coupled) to the network-based interactive systems or video conferencing systems. Such devices can also be referred to herein as sink devices or audio devices. These attached audio output devices may have differing amounts of audio delay. For example, users may participate in a video conference via a host device coupled to separate wireless audio devices for each user, such as a wireless headset, ear bud, wireless speaker, or any other device which can playback audio. These wireless audio devices may be coupled to the host device using a wireless protocol or connection (e.g., a Bluetooth™ protocol or other wireless protocol). In some cases, an audio coder-decoder (codec) is used to encode and/or decode audio signals according to the wireless protocol between the host device and the wireless headset. The audio codec may introduce some amount of audio delay.

The audio delay caused by an audio codec can be problematic. For example, while the video conference system may attempt to playback video frames and audio at the same time, there may a misalignment as between the video frames and audio due to the audio delay from the audio codec. This misalignment may be especially noticeable in scenarios where multiple participants in a conference are using a single host device. At least some portion of this delay may be due to the audio codec in use as between the host device and the wireless audio device. The audio codec may encode/decode/transcode audio data in one format to another format that is compatible with the wireless audio device. Other users may also be using other wireless headsets connected with different audio codecs with differing amounts of audio delay. Techniques to optimize around such differing amounts of audio delay may be useful.

Systems, apparatuses, electronic devices, methods (also referred to as processes), and computer-readable media (collectively referred to herein as “systems and techniques”) are described herein for optimizing codec delay values for audio devices (e.g., sink devices wirelessly connected or connected via a wire to a host device). In some aspects, the systems and techniques may include determining codec delay values associated with the audio codecs in use by the wireless audio devices, selecting a base codec and associated delay value, and determining calibration time delays for the other wireless audio devices based on the selected base codec and associated delay value.

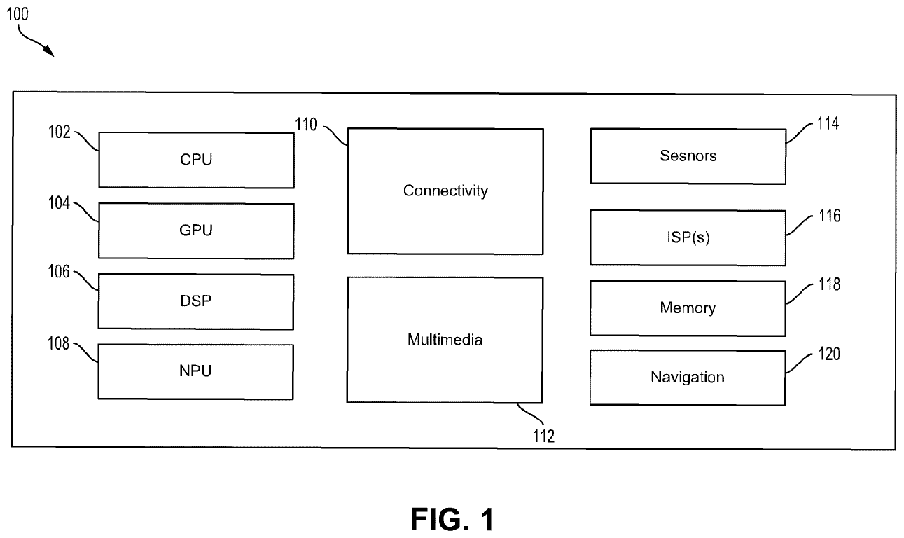

Various aspects of the present disclosure will be described with respect to the figures. FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118. In some cases, the SOC 100 may be based on an ARM instruction set.

The SOC 100 may also include additional processing blocks tailored to specific functions, such as a GPU 104, a DSP 106, a connectivity block 110, which may include fifth generation (5G) connectivity; fourth generation long term evolution (4G LTE) connectivity, Wi-Fi connectivity, USB connectivity, Bluetooth connectivity, and the like, and a multimedia block 112 that may, for example, process and/or decode audio data. In some cases, the connectivity block 110 may provide multiple connections to various networks. For example, the connectivity block 110 may provide a connection to the Internet, via the 5G connection, as well as a connection to a personal device, such as a wireless headset, via the Bluetooth connection. In some cases, the multimedia block 112 may process multimedia data for transmission via the connectivity block 110. For example, the multimedia block 112 may receive an audio bitstream, for example, via the connectivity block 110 and multimedia block 112 encode (e.g., transcode, re-encode) the audio bitstream to an audio format supported by a wireless headset that is connected via the connectivity block 110. The encoded audio bitstream may then be transmitted to the wireless headset via the connectivity block 110.

In some cases, the SOC 100 and/or components thereof, such as the multimedia block 112, may be configured to perform audio encoding and/or decoding, collectively referred to as audio coding, using a variety of audio encoder/decoders, collectively referred to as audio codecs.

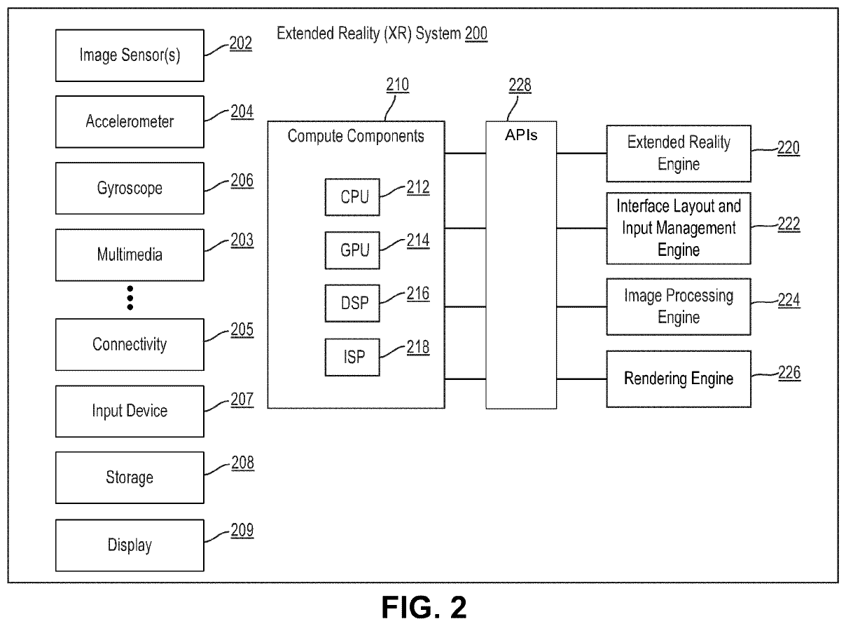

FIG. 2 is a diagram illustrating an architecture of an example extended reality (XR) system 200, in accordance with some aspects of the disclosure. In some examples, the extended reality (XR) system 200 of FIG. 2 can include the SOC 100. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a multimedia component 203, a connectivity component 205, a gyroscope 206, storage 207, compute components 210, an XR engine 220, an interface layout and input management engine 222, an image processing engine 224, and a rendering engine 226. In the example shown in FIG. 2. the engines 220-226 may access hardware components, such as components 202-218, or another engine 220-226 via one or more application programing interfaces (APIs) 228. Generally, APIs 228 are a set of functions, services, interfaces, which act as a connection between computer components, computers, or computer programs. The APIs 228 may provide a set of API calls which may be accessed by applications which allow information to be exchanged, hardware to be accessed, or other actions to be performed.

It should be noted that the components 202-228 shown in FIG. 2 are non-limiting examples provided for illustrative and explanation purposes, and other examples can include more, less, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the accelerometer 204, may be referenced in the singular form herein, it should be understood that the XR system 200 may include multiple of any component discussed herein (e.g., multiple accelerometers 204).

The XR system 200 includes or is in communication with (wired or wirelessly) an input device 208. The input device 208 can include any suitable input device, such as a touchscreen, a pen or other pointer device, a keyboard, a mouse button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, one or more image sensors 202 can capture images that can be processed for interpreting gesture commands.

In some implementations, the one or more image sensors 202, the accelerometer 204, the gyroscope 206, storage 207, multimedia component 203, compute components 210, XR engine 220, interface layout and input management engine 222, image processing engine 224, and rendering engine 226 can be part of the same computing device. For example, in some cases, the one or more image sensors 202, multimedia component 203, the accelerometer 204, the gyroscope 206, storage 207, compute components 210, APIs 228, XR engine 220, interface layout and input management engine 222, image processing engine 224, and rendering engine 226 can be integrated into an HMD, extended reality glasses, smartphone, laptop, tablet computer, gaming system, and/or any other computing device. However, in some implementations, the one or more image sensors 202, multimedia component 203, the accelerometer 204, the gyroscope 206, storage 207, compute components 210, APIs 228, XR engine 220, interface layout and input management engine 222, image processing engine 224, and rendering engine 226 can be part of two or more separate computing devices. For example. in some cases, some of the components 202-226 can be part of, or implemented by, one computing device and the remaining components can be part of, or implemented by, one or more other computing devices. In some cases, the multimedia component 203 and connectivity components may perform operations similar to the multimedia block 112 and connectivity block 110 as discussed with respect to FIG. 1.

The storage 207 can be any storage device(s) for storing data. Moreover, the storage 207 can store data from any of the components of the XR system 200. For example, the storage 207 can store data from the one or more image sensors 202 (e.g., image or video data), data for the multimedia component 203 (e.g., audio data) data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data. XR application data, face recognition data, occlusion data, etc.), data from the XR engine 220, data from the interface layout and input management engine 222, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the interface layout and input management engine 222, the image processing engine 224, and the rendering engine 226. In other examples, the compute components 210 can also implement one or more other processing engines.

The one or more image sensors 202 can include any image and/or video sensors or capturing devices. The one or more image sensors 202 can include one or more user-facing image sensors. In some cases, user-facing images sensors can be included in the one or more image sensors 202. In some examples, user-facing image sensors can be used for face tracking, eye tracking, body tracking, and/or any combination thereof. The one or more image sensors 202 can include one or more environment facing sensors. In some cases, the environment facing sensors can face in a similar direction as the gaze direction of a user. In some examples, the one or more image sensors 202 can be part of a multiple-camera assembly, such as a dual-camera assembly. The one or more image sensors 202 can capture image and/or video content (e.g., raw image and/or video data), which can then be processed by the compute components 210, the XR engine 220, the interface layout and input management engine 222, the image processing engine 224, and/or the rendering engine 226 as described herein.

In some examples, one or more image sensors 202 can capture image data and can generate images (also referred to as frames) based on the image data and/or can provide the image data or frames to the XR engine 220, the interface layout and input management engine 222, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, one or more image sensors 202 (and/or other camera of the XR system 200) can be configured to also capture depth information. For example, in some implementations, one or more image sensors 202 (and/or other camera) can include an RGB-depth (RGB-D) camera. In some cases, the XR system 200 can include one or more depth sensors (not shown) that are separate from one or more image sensors 202 (and/or other camera) and that can capture depth information. For instance, such a depth sensor can obtain depth information independently from one or more image sensors 202. In some examples, a depth sensor can be physically installed in the same general location as one or more image sensors 202 but may operate at a different frequency or frame rate from one or more image sensors 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the one or more image sensors 202 and/or the XR engine 220) can use measurements obtained by the accelerometer 204 (e.g., one or more translational vectors) and/or the gyroscope 206 (e.g., one or more rotational vectors) to calculate the pose of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of one or more image sensors 202 (or other camera of the XR system 200). In some cases, the pose of the XR system 200 and the pose of one or more image sensors 202 (or other camera) can be the same. The pose of image sensor 202 refers to the position and orientation of one or more image sensors 202 relative to a frame of reference (e.g., with respect to an object). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from one or more image sensors 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below; in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

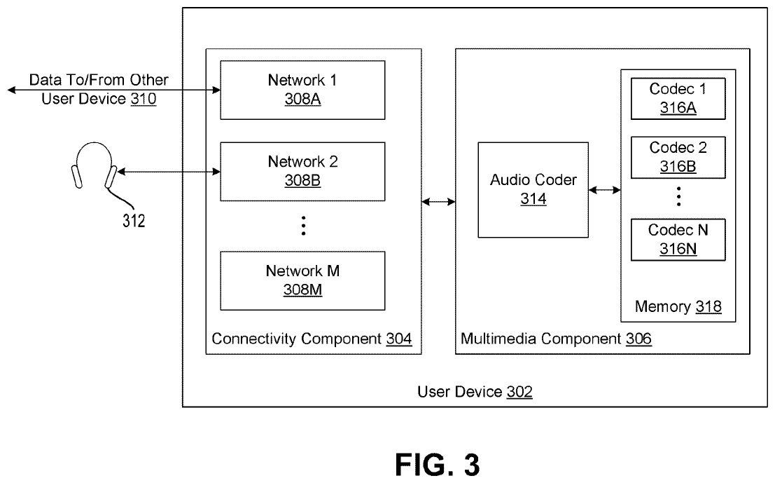

FIG. 3 is a block diagram illustrating an example architecture of a user device 302 configured for audio playback delay optimization, in accordance with aspects of the present disclosure. In this illustrative example, the user device 302 may include a connectivity component 304 coupled to a multimedia component 306. In some cases, the user device 302 may correspond to XR system 200 of FIG. 2. The connectivity component 304 may correspond to the connectivity block 110 and connectivity component 205 of FIG. 1 and FIG. 2, respectively, and the multimedia component 306 may correspond to the multimedia block 112 and multimedia component 203 of FIG. 1 and FIG. 2, respectively. It should be noted that the components 304 and 306 shown in FIG. 3 are non-limiting examples provided for illustrative and explanation purposes, and other examples can include more, less, or different components than those shown in FIG. 3.

In some examples, the connectivity component 304 may include circuitry for establishing various network connections, such as for 5G/4G connectivity, Wi-Fi connectivity, USB connectivity, Bluetooth connectivity, and the like. In this example, the connectivity component 304 of user device 302 includes network circuitry 1 308A, network circuitry 2 308B, . . . network circuitry M 308M for establishing network connections to M different networks. The network circuitry 1 308A, in this example, is coupled to another user device via one or more networks (e.g., Wi-Fi, 4G/5G, Internet, etc.) (not shown). The network circuitry 2 308B, is shown coupled to a wireless audio device 312 via a wireless protocol, such as Bluetooth, 5G, Wi-Fi. etc. The network circuity 1 308A may transmit and receive data to and from the other user device 310. In some cases, the data received from the other user device 310 may include audio data (e.g., audio bitstream) for playback by an audio output device, such as the wireless audio device 312. The audio data may be passed to the multimedia component 306. The multimedia component 306 may prepare the received audio data for playback by the audio output device.

In some cases, the multimedia component 306 includes an audio coder 314 for encoding/decoding/transcoding the received audio data. The audio coder 314 may support one or more audio codecs for encoding/decoding/transcoding. An audio codec may be a device or program for encoding/decoding/transcoding audio data. In this example, the audio coder 314 may support N audio codecs, codec 1 316A, codec 2 316B, . . . codec N 316N (collectively audio codecs 316). The audio codecs 316 may be stored in memory 318 associated with the multimedia component 306. The memory 318 may be any known memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. In some cases, the audio codecs 316 may be directly implemented (e.g., stored as dedicated circuitry for implementing the codec) by the audio coder 314.

In some cases, the audio coder 314 may output audio in either an analog or digital format. For example, where the multimedia component 306 is configured to output the received audio data to analog audio output device (e.g., wired speakers, headset, etc.) the audio coder 314 may convert the received audio data to an analog waveform for the analog audio output devices. In some cases, such as for wirelessly connected audio devices, the audio coder 314 may transcode the received audio data into a digital format compatible with the connected audio device. As an example, the wireless audio device 312 may support one or more digital audio formats over the wireless protocol. After the wireless audio device 312 establishes a wireless connection via network circuitry 2 308B, the wireless audio device 312 may transmit an indication of one or more digital audio formats (supported by the wireless audio device 312 e.g., supported codecs of the wireless audio device 312) to the user device 302. Based on the indication of the one or more supported audio formats of the wireless audio device 312, the audio coder 314 may select one or more audio codec from the audio codecs 316 supported by the user device 302 for use to transfer audio data between the user device 302 and the wireless audio device 312. The audio coder 314 may then transcode the received audio data from the other user device 310 based on the selected audio codec(s). The transcoded audio data may then be output from the audio coder 314 to the connectivity component 304 for transmission to the wireless audio device 312.

In some cases, the user device 302 may send audio data to other user devices. As an example, the wireless audio device 312 may include one or more microphones to capture audio associated with the user of the wireless audio device 312. The wireless audio device 312 may encode the captured audio using the one or more selected audio codec(s) and transmit the encoded captured audio to the user device 302 via the wireless connection and network circuitry 2 308B. The encoded captured audio may be output from the connectivity component 304 to the multimedia component 306. The audio coder 314 of the multimedia component 306 may then transcode the encoded captured audio from the selected audio codec(s) to a format compatible with data transmissions to the other devices. The transcoded captured audio may then be passed from the multimedia component 306 to the connectivity component 304 for transmission to the other user devices via network circuity 1 308A.

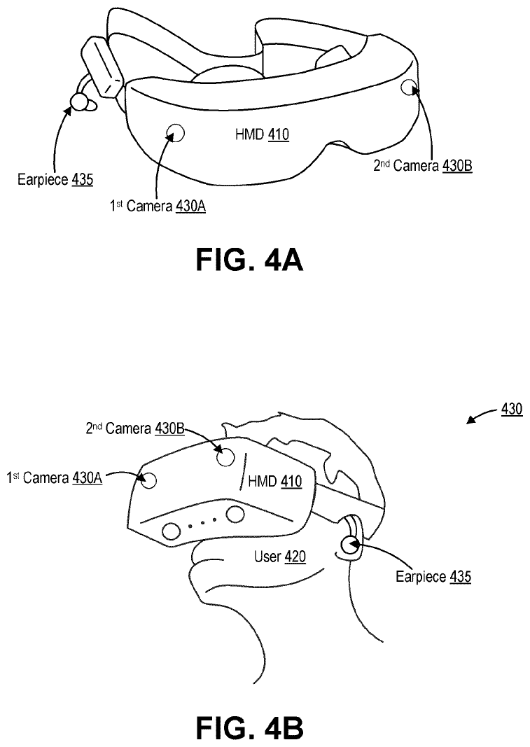

FIG. 4A is a perspective diagram 400 illustrating a head-mounted display (HMD) 410, configured for audio playback delay optimization in accordance with some examples. The HMD 410 may be, for example, an augmented reality (AR) headset, a virtual reality (VR) headset, a mixed reality (MR) headset, an extended reality (XR) headset, or some combination thereof. In some cases, HMD 410 may be an example of the user device 302. In some cases, HMD 410 may be coupled to the user device 302 via a wireless or wired connection for example, via connectivity component 304. The HMD 410 may include a first camera 430A and a second camera 430B along a front portion of the HMD 410. The first camera 430A and the second camera 430B may be two environment facing image sensors of the one or more image sensors 202 of FIG. 2. In some examples, the HMD 410 may only have a single camera. In some examples, the HMD 410 may include one or more additional cameras in addition to the first camera 430A and the second camera 430B.

The HMD 410 may include one or more earpieces 435, which may function as speakers and/or headphones that output audio to one or more ears of a user of the user device 302, and may be examples of wireless audio device 312. One earpiece 435 is illustrated in FIGS. 4A and 4B, but it should be understood that the HMD 410 can include two earpieces, with one earpiece for each ear (left ear and right ear) of the user. In some examples, the HMD 410 can also include one or more microphones (not pictured). In some examples, the audio output by the HMD 410 to the user through the one or more earpieces 435 may include, or be based on, audio recorded using the one or more microphones.

FIG. 4B is a perspective diagram 430 illustrating the head-mounted display (HMD) 410 of FIG. 4A being worn by a user 420, in accordance with some examples. The user 420 wears the HMD 410 on the user 420's head over the user 420's eyes. The HMD 410 can capture images with the first camera 430A and the second camera 430B. In some examples, the HMD 410 displays one or more display images toward the user 420's eyes that are based on the images captured by the first camera 430A and the second camera 430B. The display images may provide a stereoscopic view of the environment, in some cases with information overlaid and/or with other modifications. For example, the HMD 410 can display a first display image to the user 420's right eye, the first display image based on an image captured by the first camera 430A. The HMD 410 can display a second display image to the user 420's left eye, the second display image based on an image captured by the second camera 430B. For instance, the HMD 410 may provide overlaid information in the display images overlaid over the images captured by the first camera 430A and the second camera 430B. An earpiece 435 of the HMD 410 is illustrated in an ear of the user 420. The HMD 410 may be outputting audio to the user 420) through the earpiece 435 and/or through another earpiece (not pictured) of the HMD 410 that is in the other ear (not pictured) of the user 420.

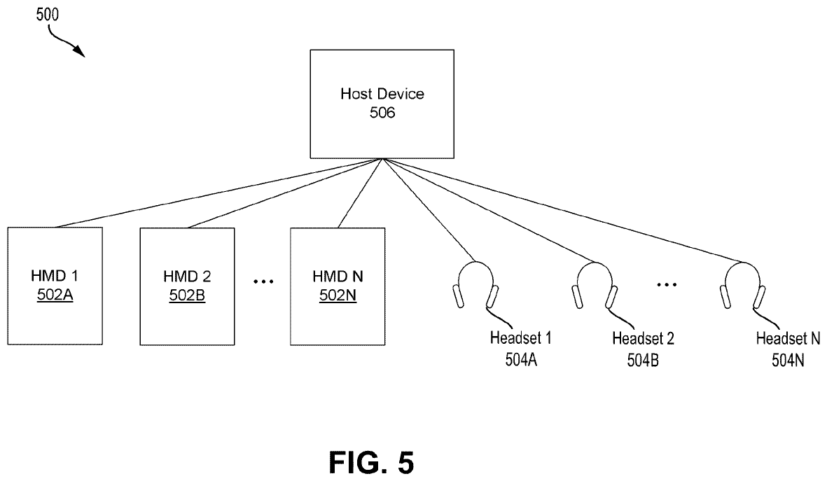

In some cases, multiple people may be participating in a multi-user environment such as a teleconference or shared XR environment using a shared host device. For example. multiple participants for a multi-user environment may be in a shared physical environment and the multiple participants may have their own participant audio-visual systems, such as an HMD, where the participant audio-visual systems are coupled to a shared host device. In such a case, the shared host device may coordinate and/or transmit/receive audio/video information to the participant audio-visual systems. FIG. 5 is a logical view of a multi-user environment 500 with a shared host device, in accordance with aspects of the present disclosure. In environment 500 a host device 506 may be electronically coupled to one or more HMD devices 502A, 502B, . . . 502N (collectively 502). The host device 506 may provide data regarding the visual environment of the multi-user environment to the HMD devices 502. The host device may also be electronically coupled to one or more wireless headsets 504A, 504B, . . . 504N (collectively referred to as wireless headsets 504). The wireless headsets 504 may each be associated with an HMD device 502. For example, HMD device 1 502A may be associated with wireless headset 1 504A. HMD device 2 5022 may be associated with wireless headset 2 504B, etc. While a wireless headset 504 may be associated with an HMD device 502, the wireless headset 504 may be electronically coupled directly to the host device 506 via a wireless connection separate from the connection between the host device 506 and the HMD devices 502. Examples of this wireless connection may include Bluetooth, Wi-Fi, cellular signals, etc.

In some cases, the wireless headsets 504 can potentially support a variety of different audio codecs. Different audio codecs may be associated with varying amounts of latency (e.g., delay time). In some cases, techniques for audio delay optimizations may be used to mitigate the effects of the differing latencies of the different audio codecs.

In some cases, the host device 506 may coordinate and/or determine delay calibration times as among a plurality of devices (referred to herein as sink devices), such as wireless headsets 504. Sink devices may be any wireless audio device coupled to the host device.

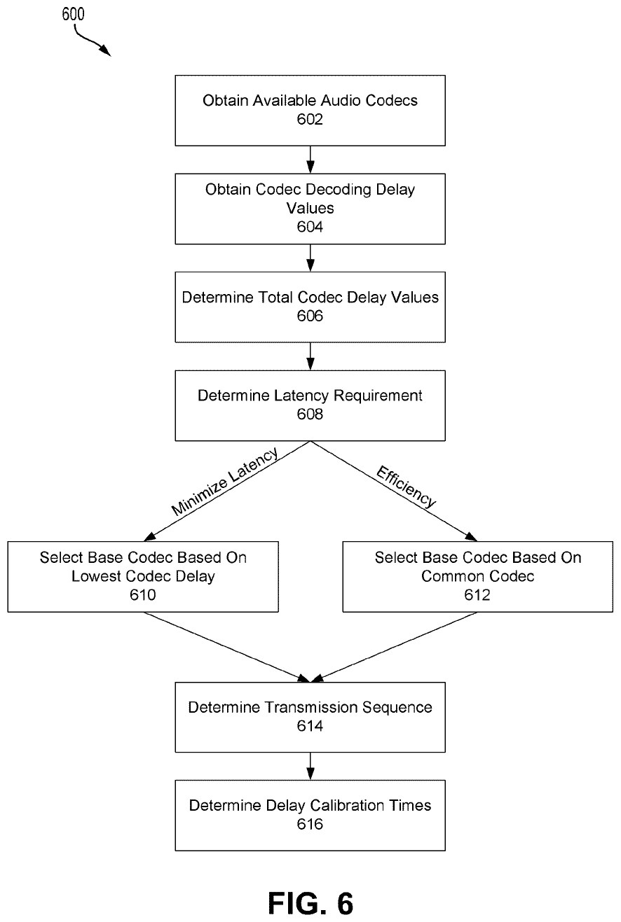

FIG. 6 is a flow diagram 600 illustrating processes of a host device, in accordance with aspects of the present disclosure. At process 602, the host device may obtain, from the sink devices, available audio codecs. In some cases, audio data for a sink device may be reencoded (e.g., transcoded) by a host device into a format that is supported by a sink device for transmission to the sink device. In many cases, audio devices may support multiple audio codecs. As an example, a first wireless headset connected by Bluetooth may support a standard SBC codec as well as ACC, LC3 and aptX-HD audio codecs. Another wireless headset also connected by Bluetooth may support SBC along with AAC and LC3 audio codecs. In some cases, the audio codecs supported by a sink device may be exchanged with the host device during a paring or setup process.

At process 604, the host device may obtain codec decoding delay values from host devices. In some cases, audio codecs are associated with a certain amount of delay (e.g., codec delay). Each audio codec may have a certain amount of codec decoding delay. This codec decoding delay may represent an amount of time for the audio data to be transmitted and decoded by the wireless audio device. In some cases, the host device may query sink devices for codec decoding delay values for the codecs supported by the respective sink device and the sink devices may response with their respective codec decoding delay values per supported codec. In cases where a sink device does not provide a codec decoding delay value for an available audio codec, the host device may estimate a codec decoding delay value for the available codec by using a codec specific default codec decoding delay value. In some cases, the codec decoding delay may be dynamically determined, for example, via test tones. In addition to the codec decoding delay, reencoding the audio data into the format that is supported by the sink device incurs some time and there may be some additional codec encoding delay incurred by the host. The exact codec encoding delay value may vary based on the codec and host device. The expected encoding delay value may be added to the codec decoding delay value to determine a per codec total codec delay value at process 606.

At process 608, a latency requirement is determined. For example, some applications, such as gaming applications, may prioritize low latencies to allow participants to quickly respond to the application. The application may indicate to the host device (e.g., to an application performing the audio stream delay optimization) that the application prioritizes low latency. In some examples, the indication that the application prioritizes low latency may be an explicit indication, such as a flag, or implicit, such as via an application type indication, or even a lack of an indication (e.g., default setting). In such cases, execution may proceed to process 608. In other cases, some applications, such as for a content playback for music, video, movies, etc., low latency may not be a priority. In some cases, the application may indicate to the host device that the application does not prioritize low latency. In some cases, this indication may explicit, such as a flag, or implicit, for example, via an application type indication, or even a lack of an indication (e.g., default setting). Where low latency is not a priority, execution may proceed to process 610.

At process 610, a base codec is selected based on a lowest codec decoding delay. As an example, a host device, such as host device 506, may be coupled to four sink devices which have available codecs with corresponding total codec delay values as shown in Table 1. It should be understood that the total codec delay values shown in Table 1 are illustrative and may not represent actual delay values.

TABLE 1

| Sink | Available | Total |
|---|---|---|
| Device | Codecs | Codec Delay |
| Wireless headset 1 | ACC, LC3, LDAC | 330 ms, 120 ms, 220 ms |
| Wireless headset 2 | LC3, aptX-HD | 120 ms, 290 ms |
| Wireless headset 3 | LDAC, aptX-HD | 220 ms, 290 ms |
| Wireless earbud 4 | ACC, aptX-HD | 330 ms, 290 ms |

Where low latency is prioritized, the codec with the lowest overall total codec delay value may be selected as a base codec, here the LC3 codec with a corresponding 120 ms delay. An available codec associated with the lowest total codec delay for each sink device may also be selected. Thus, the LC3 codec may be selected for wireless headset 1 and wireless headset 2, the LDAC codec selected for wireless headset 3, and the aptX-HD codec selected for wireless earbud 4.

Where low latency is not prioritized, at process 612, the codec that is most commonly shared between the sink devices is selected as the base codec. Continuing the earlier example using the sink devices as shown in Table 1, as three out of the four sink devices support aptX-HD, aptX-HD is selected as the base codec. In some cases, for sink devices which do not support the base codec, an available codec associated with the lowest total codec delay may be selected. In this example, the LC3 codec may be selected for wireless headset 1. In some cases, codecs for sink devices where an available codec (e.g., remaining sink devices) has not yet been selected may be selected from among codecs common to the remaining sink devices (e.g., most common codec as among the remaining sink devices). In some cases, codecs for the remaining sink devices may be selected based on the codec associated with the lowest total codec delay of those codecs associated with a sink device.

At process 614, a transmission sequence may be determined. To help synchronize the presentation of the audio as closely as possible, the host device may transmit audio data to sink devices that are using audio codecs with the highest total codec delay ahead of sink devices which are using audio codecs with lower total codec delays. In some cases, the transmission sequence may be determined by sorting the total codec delay values for the selected codecs of each sink device in decreasing order. Continuing the earlier example using the sink devices as shown in Table 1, where low latency is prioritized, the sink devices may be ordered as follows: wireless earbuds 4 (aptX-HD, 290 ms), wireless headset 3 (LDAC, 220 ms), wireless headset 1 and wireless headset 2 (both LC3, 120 ms). Where latency is not prioritized, the sink devices as shown in Table 1 may be ordered as follows: wireless headset 2, wireless headset 3, and wireless earbuds 4 (which all use aptX-HD, 290 ms), and wireless headset 1 (LC3, 120 ms). In some cases, where multiple sink devices have the same total codec delay values (e.g., wireless headset 1 and wireless headset 2 where low latency is prioritized and wireless headset 2, wireless headset 3, and wireless earbuds 4 where latency is not prioritized), the exact order for sink devices with the same total codec delay value may be an implementation decision.

At process 616, calibration delay times may be determined. Some sink devices may support a delay calibration functionality where the sink device may delay playback of a received audio stream by a certain amount of time. In some cases, calibration delay times may be determined based on a difference between the total codec delay value of the selected base codec and the total codec delay value of the codec selected for each of the sink devices. Continuing the earlier example using the sink devices as shown in Table 1, where low latency is prioritized and the base codec is LC3, the calibration delay times may be 170 ms for wireless earbuds 4, 100 ms for wireless headset 3, and no calibration delay for wireless headset 1 and wireless headset 2. Where latency is not prioritized and the base codec is aptX-HD, the calibration delay times may be −170 ms for wireless headset 1. Generally, the host device may optimize and align audio data (e.g., stream) playback by the sink devices by either adjusting the times the audio data is encoded and transmitted to the sink devices based on the calibration delay times, or cause the sink devices to delay play back based on the calibration delay times.

In some cases, the audio data for the sink devices may be encoded to the selected audio codec and transmitted to the corresponding sink device based on the calibration delay times. Continuing the earlier example where low latency is prioritized, audio data for wireless earbuds 4 may be encoded to aptX-HD and transmitted to wireless earbuds 4 170 ms prior to encoding and transmitting the base LC3 codec. Similarly, audio data for wireless headset 3 may be encoded to LDAC and transmitted to wireless headset 3 100 ms prior to encoding and transmitting the base LC3 codec. Audio data for wireless headset 1 and wireless headset 2 may then be encoded to LC3 and transmitted 100 ms after audio data for wireless headset 3 is encoded and transmitted. In the example where latency is not prioritized, as the base codec has a larger delay value and wireless headset 1 has a negative calibration delay time, audio data for wireless headset 2, wireless headset 3, and wireless earbuds 4 are encoded and transmitted 170 ms before audio data for wireless headset 1 is encoded and transmitted.

In some cases, an audio sink devices may support a delay calibration functionality, where the audio sink device may receive the audio data and then delay playback of the audio based on the calibration delay time received with the audio data. In such cases, the calibration delay times may be adjusted as needed and sent along with the audio data stream.

In some cases, one or more sink device may be connected via a wireless connection that support quality of service (QoS) flow sequences, such as a cellular 5G NR connection. In such cases, the host device may determine delay calibration times based on available QoS flow sequences for transmitting to the sink device. For example, the host device, such as host device 506, may query a QoS cloud or edge server to enumerate the available audio codec types and corresponding codec decoding delays for sink devices using QoS flow sequences. In some cases, the QoS cloud or edge server may provide the available audio codec types and corresponding codec decoding delays instead of the sink devices. The QoS cloud or edge server may also provide available QoS flows. The available QoS flows may be associated with different delays. For example, a first QoS flow may have a delay of 120 ms, a second QoS flow may have a delay of 20 ms. The host device may pair the sink devices based on available QoS flow delays and the calibration delay times and adjust a delay time for encoding and transmitting the audio data accordingly. For example, codecs associated with the longer delays may be paired with QoS flows with lower delays. Continuing the earlier example using the sink devices as shown in Table 1 and where low latency is prioritized, the calibration delay times may be 170 ms for wireless earbuds 4 and the audio data may be encoded and transmitted to wireless earbuds 4 using the second QoS flow with an additional 20 ms of delay, for a total delay of 190 ms. As the calibration delay for wireless headset 3 is 100 ms, the audio data may be transmitted to wireless headset 3 using the second QoS flow, which has an additional 20 ms of delay, delayed from the encoding and transmission to wireless earbuds 4 by 50 ms. As there is no calibration delay for wireless headset 1 and wireless headset 2, audio data for wireless headset 1 and wireless headset 2 may be encoded and transmitted on the first QoS flow, which has a delay of 120 ms, with a 50 ms delay.

In some cases, one or more sink device may be connected via a wireless connection that supports isochronous channels. For example. Bluetooth LE supports connected isochronous groups (CIGs) and a CIG event may include one or more connected isochronous streams (CISs). Each CIS may have a different delay time based on when the CIS is transmitted in a CIG event. In some cases, the host device may determine CIS sequences and CIS order based on total codec delays and codecs with larger total codec delays may be transmitted earlier in a CIG event. In some cases, the host device may pair CIS sequences with the calibration delay times such that audio data associated with a longest total codec delay are paired with CISs with smaller CIS delays and a delay time for encoding and transmitting the audio data may be added accordingly. For example, a CIG may have eight CIS. CISO-CIS7, where CISO has the longest CIS_Sync_delay at 120 ms and CIS7 has shortest CIS_sync_delay at 20 ms. Continuing the earlier example using the sink devices as shown in Table 1 and where low latency is prioritized, the calibration delay times may be 170 ms for wireless earbuds 4 and the audio data may be encoded and transmitted to wireless earbuds 4 using CIS7 with an additional 20 ms of delay (e.g., CIS_sync_delay) for a total delay of 190 ms. Assuming that CIS 5 has 60 ms of delay (e.g., CIS_sync_delay), audio data for wireless headset 3, which has 100 ms calibration delay, may be delayed for 30 ms. Generally additional delay that may be added for a CIS may be a difference between a maximum delay calibration time for an available sink device+CIS delay (here 190 ms) and a current delay calibration time+CIS delay, such as 100 ms+60 ms). Thus, and additional delay time is reduced by transmitting audio data for a sink device associated with a larger codec delay earlier in the CIG. In some cases, if different total codec delay differences are relatively small across the sink devices (e.g., smaller than a CIG_Sync_delay), CIS event interleaved transmission may be used. In some cases, if different total codec delay differences are relatively large across the sink devices (e.g., larger than a CIG_Sync_delay), CIS event sequential transmission may be used.

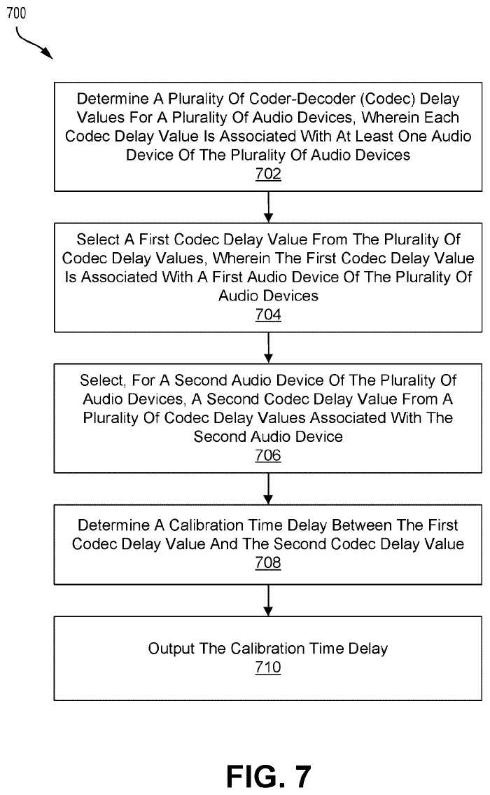

FIG. 7 is a flow diagram illustrating a process for audio processing 700, in accordance with aspects of the present disclosure. At operation 702, the process 700 includes determining a plurality of coder-decoder (codec) delay values for a plurality of audio devices, wherein each codec delay value is associated with at least one audio device of the plurality of audio devices. In some cases, the process 700 further includes querying audio devices of the plurality of audio devices for available audio codecs, receiving an indication of the available audio codecs associated with the audio devices of plurality of audio devices, and associating the available audio codecs of the audio devices and corresponding codec delay values. In some cases, the process 700 further includes querying the plurality of audio devices for codec delay values associated with the plurality of audio devices. In some cases, the process 700 further includes determining that codec delay values have not been received from a third audio device and estimating codec delay values for available audio codecs of the third audio device based on the available audio codecs of the third audio device.

At operation 704, the process 700 includes selecting a first codec delay value from the plurality of codec delay values, wherein the first codec delay value is associated with a first audio device of the plurality of audio devices. In some cases, the process 700 further includes selecting the first codec delay value for the first audio device based on a most common codec available for the plurality of audio devices. In some cases, the process 700 further includes selecting the first codec delay value based on a lowest codec delay value from the plurality of codec delay values for the plurality of audio devices.

At operation 706, the process 700 includes selecting, for a second audio device of the plurality of audio devices, a second codec delay value from a plurality of codec delay values associated with the second audio device. In some cases, the process 700 further includes selecting the second codec delay value for the second audio device based on a second most common codec of audio devices that are not associated with the most common codec. In some cases, the process 700 further includes selecting the second codec delay value for the second audio device based on a lowest codec delay value from the plurality of codec delay values associated with the second audio device.

At operation 708, the process 700 includes determining a calibration time delay between the first codec delay value and the second codec delay value. At operation 710, the process 700 includes outputting the calibration time delay. In some cases, the process 700 further includes transmitting an output calibration time delay associated with the first audio device to the first audio device with an audio stream. In some cases, the process 700 further includes determining a transmission order for the plurality of audio devices based on selected codec delay values associated with the plurality of audio devices, wherein the transmission order is based on a decreasing order of the selected codec delay values. In some cases, the process 700 further includes scheduling transmissions to the first audio device and the second audio device based on the transmission order, the selected first codec delay value, and the selected second codec delay value and transmitting audio streams to the first audio device and the second audio device based on the scheduled transmissions.

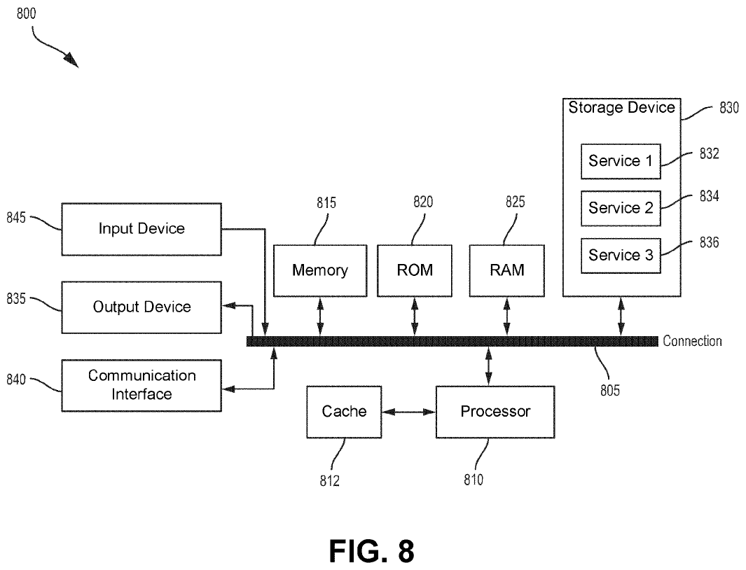

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 800 may include SOC 100 of FIG. 1 and/or user device 302 of FIG. 3. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing. containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of”' a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

### Aspect 1

An apparatus for audio processing comprising: at least one memory; and at least one processor coupled to the at least one memory and a plurality of audio devices, wherein the at least one processor is configured to: determine a plurality of coder-decoder (codec) delay values for the plurality of audio devices, wherein each codec delay value is associated with at least one audio device of the plurality of audio devices; select a first codec delay value from the plurality of codec delay values, wherein the first codec delay value is associated with a first audio device of the plurality of audio devices; select, for a second audio device of the plurality of audio devices, a second codec delay value from a plurality of codec delay values associated with the second audio device; determine a calibration time delay between the first codec delay value and the second codec delay value; and output the calibration time delay.

### Aspect 2

The apparatus of claim 1, wherein the at least one processor is further configured to: query audio devices of the plurality of audio devices for available audio codecs; receive an indication of the available audio codecs associated with the audio devices of plurality of audio devices; and associate the available audio codecs of the audio devices and corresponding codec delay values.

### Aspect 3

The apparatus of claim 2, wherein the at least one processor is further configured to query the plurality of audio devices for codec delay values associated with the plurality of audio devices.

### Aspect 4

The apparatus of claim 3, wherein the at least one processor is further configured to: determine that codec delay values have not been received from a third audio device; and estimate codec delay values for available audio codecs of the third audio device based on the available audio codecs of the third audio device.

### Aspect 5

The apparatus of any of claims 1-4, wherein the at least one processor is further configured to select the first codec delay value for the first audio device based on a most common codec available for the plurality of audio devices.

### Aspect 6

The apparatus of claim 5, wherein the at least one processor is further configured to select the second codec delay value for the second audio device based on a second most common codec of audio devices that are not associated with the most common codec.

### Aspect 7

The apparatus of claim 5, wherein the at least one processor is further configured to select the second codec delay value for the second audio device based on a lowest codec delay value from the plurality of codec delay values associated with the second audio device.

### Aspect 8

The apparatus of any of claims 1-4, wherein the at least one processor is further configured to select the first codec delay value based on a lowest codec delay value from the plurality of codec delay values for the plurality of audio devices.

### Aspect 9

The apparatus of any of claims 1-8, wherein the at least one processor is further configured to transmit an output calibration time delay associated with the first audio device to the first audio device with an audio stream.

### Aspect 10

The apparatus of any of claims 1-9, wherein the at least one processor is further configured to determine a transmission order for the plurality of audio devices based on selected codec delay values associated with the plurality of audio devices, wherein the transmission order is based on a decreasing order of the selected codec delay values.

### Aspect 11

The apparatus of claim 10, wherein the at least one processor is further configured to: schedule transmissions to the first audio device and the second audio device based on the transmission order, the selected first codec delay value, and the selected second codec delay value; and transmit audio streams to the first audio device and the second audio device based on the scheduled transmissions.

### Aspect 12

A method for audio processing comprising: determining a plurality of coder-decoder (codec) delay values for a plurality of audio devices, wherein each codec delay value is associated with at least one audio device of the plurality of audio devices; selecting a first codec delay value from the plurality of codec delay values, wherein the first codec delay value is associated with a first audio device of the plurality of audio devices; selecting, for a second audio device of the plurality of audio devices, a second codec delay value from a plurality of codec delay values associated with the second audio device; determining a calibration time delay between the first codec delay value and the second codec delay value; and outputting the calibration time delay.

### Aspect 13

The method of claim 12, further comprising: querying audio devices of the plurality of audio devices for available audio codecs; receiving an indication of the available audio codecs associated with the audio devices of plurality of audio devices; and associating the available audio codecs of the audio devices and corresponding codec delay values.

### Aspect 14

The method of claim 13, further comprising querying the plurality of audio devices for codec delay values associated with the plurality of audio devices.

### Aspect 15

The method of claim 14, further comprising: determining that codec delay values have not been received from a third audio device; and estimating codec delay values for available audio codecs of the third audio device based on the available audio codecs of the third audio device.

### Aspect 16

The method of any of claims 12-15, further comprising selecting the first codec delay value for the first audio device based on a most common codec available for the plurality of audio devices.

### Aspect 17

The method of claim 16, further comprising selecting the second codec delay value for the second audio device based on a second most common codec of audio devices that are not associated with the most common codec.

### Aspect 18

The method of claim 16, further comprising selecting the second codec delay value for the second audio device based on a lowest codec delay value from the plurality of codec delay values associated with the second audio device.

### Aspect 19

The method of any of claims 12-15, further comprising selecting the first codec delay value based on a lowest codec delay value from the plurality of codec delay values for the plurality of audio devices.

### Aspect 20

The method of any of claims 12-19, further comprising transmitting an output calibration time delay associated with the first audio device to the first audio device with an audio stream.

### Aspect 21

The method of any of claims 12-20, further comprising determining a transmission order for the plurality of audio devices based on selected codec delay values associated with the plurality of audio devices, wherein the transmission order is based on a decreasing order of the selected codec delay values.

### Aspect 22

The method of claim 21, further comprising: scheduling transmissions to the first audio device and the second audio device based on the transmission order, the selected first codec delay value, and the selected second codec delay value; and transmitting audio streams to the first audio device and the second audio device based on the scheduled transmissions.

### Aspect 23

A non-transitory computer-readable medium having stored thereon instructions that, when executed by at least one processor, cause the at least one processor to: determine a plurality of coder-decoder (codec) delay values for a plurality of audio devices, wherein each codec delay value is associated with at least one audio device of the plurality of audio devices; select a first codec delay value from the plurality of codec delay values, wherein the first codec delay value is associated with a first audio device of the plurality of audio devices; select, for a second audio device of the plurality of audio devices, a second codec delay value from a plurality of codec delay values associated with the second audio device; determine a calibration time delay between the first codec delay value and the second codec delay value; and output the calibration time delay.

### Aspect 24

The non-transitory computer-readable medium of claim 23, wherein the instructions further cause the at least one processor to: query audio devices of the plurality of audio devices for available audio codecs; receive an indication of the available audio codecs associated with the audio devices of plurality of audio devices; and associate the available audio codecs of the audio devices and corresponding codec delay values.

### Aspect 25

The non-transitory computer-readable medium of claim 24, wherein the instructions further cause the at least one processor to query the plurality of audio devices for codec delay values associated with the plurality of audio devices.

### Aspect 26

The non-transitory computer-readable medium of claim 25, wherein the instructions further cause the at least one processor to: determine that codec delay values have not been received from a third audio device; and estimate codec delay values for available audio codecs of the third audio device based on the available audio codecs of the third audio device.

### Aspect 27

The non-transitory computer-readable medium of any of claims 23-26, wherein the instructions further cause the at least one processor to select the first codec delay value for the first audio device based on a most common codec available for the plurality of audio devices.

### Aspect 28

The non-transitory computer-readable medium of claim 27, wherein the instructions further cause the at least one processor to select the second codec delay value for the second audio device based on a second most common codec of audio devices that are not associated with the most common codec.

### Aspect 29

The non-transitory computer-readable medium of claim 27, wherein the instructions further cause the at least one processor to select the second codec delay value for the second audio device based on a lowest codec delay value from the plurality of codec delay values associated with the second audio device.

### Aspect 30

The non-transitory computer-readable medium of any of claims 23-26, wherein the instructions further cause the at least one processor to select the first codec delay value based on a lo west codec delay value from the plurality of codec delay values for the plurality of audio devices.

### Aspect 31

The non-transitory computer-readable medium of any of claims 23-30, wherein the instructions further cause the at least one processor to transmit an output calibration time delay associated with the first audio device to the first audio device with an audio stream.

### Aspect 32

The non-transitory computer-readable medium of any of claims 23-31, wherein the instructions further cause the at least one processor to determine a transmission order for the plurality of audio devices based on selected codec delay values associated with the plurality of audio devices, wherein the transmission order is based on a decreasing order of the selected codec delay values.

### Aspect 33

The non-transitory computer-readable medium of claim 32, wherein the instructions further cause the at least one processor to: schedule transmissions to the first audio device and the second audio device based on the transmission order, the selected first codec delay value, and the selected second codec delay value; and transmit audio streams to the first audio device and the second audio device based on the scheduled transmissions

### Aspect 34

An apparatus comprising means for performing a method according to any of Aspects 12 to 22.

1. An apparatus for audio processing comprising:
at least one memory; and
at least one processor coupled to the at least one memory and a plurality of audio devices, wherein the at least one processor is configured to:
determine a plurality of coder-decoder (codec) delay values for the plurality of audio devices, wherein each codec delay value is associated with at least one audio device of the plurality of audio devices;
select a first codec delay value from the plurality of codec delay values, wherein the first codec delay value is associated with a first audio device of the plurality of audio devices;
select, for a second audio device of the plurality of audio devices, a second codec delay value from a plurality of codec delay values associated with the second audio device;
determine a calibration time delay between the first codec delay value and the second codec delay value; and
output the calibration time delay.

2. The apparatus of claim 1, wherein the at least one processor is further configured to:
query audio devices of the plurality of audio devices for available audio codecs;
receive an indication of the available audio codecs associated with the audio devices of plurality of audio devices; and
associate the available audio codecs of the audio devices and corresponding codec delay values.

3. The apparatus of claim 2, wherein the at least one processor is further configured to query the plurality of audio devices for codec delay values associated with the plurality of audio devices.

4. The apparatus of claim 3, wherein the at least one processor is further configured to:
determine that codec delay values have not been received from a third audio device; and
estimate codec delay values for available audio codecs of the third audio device based on the available audio codecs of the third audio device.

5. The apparatus of claim 1, wherein the at least one processor is further configured to select the first codec delay value for the first audio device based on a most common codec available for the plurality of audio devices.

6. The apparatus of claim 5, wherein the at least one processor is further configured to select the second codec delay value for the second audio device based on a second most common codec of audio devices that are not associated with the most common codec.

7. The apparatus of claim 5, wherein the at least one processor is further configured to select the second codec delay value for the second audio device based on a lowest codec delay value from the plurality of codec delay values associated with the second audio device.

8. The apparatus of claim 1, wherein the at least one processor is further configured to select the first codec delay value based on a lowest codec delay value from the plurality of codec delay values for the plurality of audio devices.

9. The apparatus of claim 1, wherein the at least one processor is further configured to transmit an output calibration time delay associated with the first audio device to the first audio device with an audio stream.

10. The apparatus of claim 1, wherein the at least one processor is further configured to determine a transmission order for the plurality of audio devices based on selected codec delay values associated with the plurality of audio devices, wherein the transmission order is based on a decreasing order of the selected codec delay values.

11. The apparatus of claim 10, wherein the at least one processor is further configured to:
schedule transmissions to the first audio device and the second audio device based on the transmission order, the selected first codec delay value, and the selected second codec delay value; and
transmit audio streams to the first audio device and the second audio device based on the scheduled transmissions.

12. A method for audio processing comprising:
determining a plurality of coder-decoder (codec) delay values for a plurality of audio devices, wherein each codec delay value is associated with at least one audio device of the plurality of audio devices;
selecting a first codec delay value from the plurality of codec delay values, wherein the first codec delay value is associated with a first audio device of the plurality of audio devices;
selecting, for a second audio device of the plurality of audio devices, a second codec delay value from a plurality of codec delay values associated with the second audio device;
determining a calibration time delay between the first codec delay value and the second codec delay value; and
outputting the calibration time delay.

13. The method of claim 12, further comprising:
querying audio devices of the plurality of audio devices for available audio codecs;
receiving an indication of the available audio codecs associated with the audio devices of plurality of audio devices; and
associating the available audio codecs of the audio devices and corresponding codec delay values.

14. The method of claim 13, further comprising querying the plurality of audio devices for codec delay values associated with the plurality of audio devices.

15. The method of claim 14, further comprising:
determining that codec delay values have not been received from a third audio device; and
estimating codec delay values for available audio codecs of the third audio device based on the available audio codecs of the third audio device.

16. The method of claim 12, further comprising selecting the first codec delay value for the first audio device based on a most common codec available for the plurality of audio devices.

17. The method of claim 16, further comprising selecting the second codec delay value for the second audio device based on a second most common codec of audio devices that are not associated with the most common codec.

18. The method of claim 16, further comprising selecting the second codec delay value for the second audio device based on a lowest codec delay value from the plurality of codec delay values associated with the second audio device.

19. The method of claim 12, further comprising selecting the first codec delay value based on a lowest codec delay value from the plurality of codec delay values for the plurality of audio devices.

20. The method of claim 12, further comprising transmitting an output calibration time delay associated with the first audio device to the first audio device with an audio stream.

21. The method of claim 12, further comprising determining a transmission order for the plurality of audio devices based on selected codec delay values associated with the plurality of audio devices, wherein the transmission order is based on a decreasing order of the selected codec delay values.

22. The method of claim 21, further comprising:
scheduling transmissions to the first audio device and the second audio device based on the transmission order, the selected first codec delay value, and the selected second codec delay value; and
transmitting audio streams to the first audio device and the second audio device based on the scheduled transmissions.

23. A non-transitory computer-readable medium having stored thereon instructions that, when executed by at least one processor, cause the at least one processor to:
determine a plurality of coder-decoder (codec) delay values for a plurality of audio devices, wherein each codec delay value is associated with at least one audio device of the plurality of audio devices;
select a first codec delay value from the plurality of codec delay values, wherein the first codec delay value is associated with a first audio device of the plurality of audio devices;
select, for a second audio device of the plurality of audio devices, a second codec delay value from a plurality of codec delay values associated with the second audio device;
determine a calibration time delay between the first codec delay value and the second codec delay value; and
output the calibration time delay.

24. The non-transitory computer-readable medium of claim 23, wherein the instructions further cause the at least one processor to:
query audio devices of the plurality of audio devices for available audio codecs;
receive an indication of the available audio codecs associated with the audio devices of plurality of audio devices; and
associate the available audio codecs of the audio devices and corresponding codec delay values.

25. The non-transitory computer-readable medium of claim 24, wherein the instructions further cause the at least one processor to query the plurality of audio devices for codec delay values associated with the plurality of audio devices.

26. The non-transitory computer-readable medium of claim 25, wherein the instructions further cause the at least one processor to:
determine that codec delay values have not been received from a third audio device; and
estimate codec delay values for available audio codecs of the third audio device based on the available audio codecs of the third audio device.

27. The non-transitory computer-readable medium of claim 23, wherein the instructions further cause the at least one processor to select the first codec delay value for the first audio device based on a most common codec available for the plurality of audio devices.

28. (canceled)

29. (canceled)

30. The non-transitory computer-readable medium of claim 23, wherein the instructions further cause the at least one processor to select the first codec delay value based on a lowest codec delay value from the plurality of codec delay values for the plurality of audio devices.

31. The non-transitory computer-readable medium of claim 23, wherein the instructions further cause the at least one processor to transmit an output calibration time delay associated with the first audio device to the first audio device with an audio stream.

32. The non-transitory computer-readable medium of claim 23, wherein the instructions further cause the at least one processor to determine a transmission order for the plurality of audio devices based on selected codec delay values associated with the plurality of audio devices, wherein the transmission order is based on a decreasing order of the selected codec delay values.

33. (canceled)

34. (canceled)
